(19) United States
(12) Patent Application Publication
(10) Pub. No.: US 2024/0383710 A1
(43) Pub. Date: Nov. 21, 2024

(54) DEVICE FOR AUTOMATICALLY CONNECTING MATERIAL AND SYSTEM FOR MANUFACTURING MATERIAL INCLUDING THE SAME

(71) Applicants: Hyundai Motor Company, Seoul (KR); Kia Corporation, Seoul (KR)

(72) Inventors: Chan Bum Park, Suwon (KR); Young Soon Lee, Yongin (KR); Hyeon Ha Lee, Anyang (KR); Han Nah Song, Suwon (KR)

(21) Appl. No.: 18/389,534

(22) Filed: Nov. 14, 2023

(30) Foreign Application Priority Data
May 15, 2023 (KR) 10-2023-0062415

(51) Int. Cl. B65H 19/18; B65H 19/20; B65H 23/182; H01M 4/04; H01M 10/04

(52) U.S. Cl. CPC B65H 19/18; B65H 19/20; B65H 23/1825; H01M 4/0435; H01M 10/0409; B65H 2301/44318; B65H 2301/44336; B65H 2701/18442; B65H 2701/19

(57) ABSTRACT

Described is a device for automatically connecting a continuously manufactured material, the device including a fixed roller rotatably fixed, the fixed roller being rotatable about the shaft of the fixed roller, a swing roller connected to the fixed roller and rotatable by the rotation of the fixed roller, the swing roller being rotatable about the shaft of the swing roller, and a holder plate, connected to the fixed roller, rotatable together with the fixed roller, and configured to hold the material. Also described are a system and a method for manufacturing a material.

### CROSS-REFERENCE TO RELATED APPLICATION

This application claims, under 35 U.S.C. § 119 (a), the benefit of Korean Patent Application No. 10-2023-0062415, filed on May 15, 2023, the entire contents of which are incorporated herein by reference.

### TECHNICAL FIELD

Embodiments of the present disclosure relate to a device for automatically connecting a continuously manufactured material.

### DESCRIPTION OF THE RELATED ART

A secondary battery is recently expanding its use in various fields, such as an electronic device, an electric vehicle, and an energy storage device. A type widely used as a secondary battery may be, for example, a lithium ion battery.

The electrode of the secondary battery has been generally manufactured through a wet process. However, a dry electrode manufactured through a dry process, which has various advantages, has recently appeared. The advantages may include that a solvent used in the wet process is not needed when manufacturing a dry electrode, that the energy density of the battery may be increased, and that the cost for producing the battery may be reduced. The dry electrode is manufactured by pressing dry electrode powder.

### SUMMARY OF THE DISCLOSURE

Embodiments of the present disclosure have been made in an effort to solve the above-described problems associated with the existing technologies, and it is an object of the present disclosure to provide a device for automatically connecting a material, the device configured to automatically connect a continuously manufactured material to a new winder.

The object of the present disclosure is not limited to the foregoing, and other objects not mentioned herein will be clearly understood by those of ordinary skill in the art to which the present disclosure pertains (hereinafter, “those skilled in the art”) based on the description below.

In one embodiment, the present disclosure provides a device for automatically connecting a material, the device including a fixed roller rotatably fixed, the fixed roller being rotatable about the shaft of the fixed roller, a swing roller and rotatable by the rotation of the fixed roller, the swing roller being rotatable about the shaft of the swing roller, and a holder plate rotatable together with the fixed roller, and configured to hold the material.

The holder plate may be connected to the fixed roller via the swing roller. The device may further comprise a proximal link configured to connect the swing roller and the fixed roller to each other. The device may further comprise a distal link configured to connect the swing roller and the holder plate to each other. The holder plate may be configured to hold the material by vacuum adsorption. The holder plate may include a plurality of holes for the vacuum adsorption. The holder plate may include a protrusible cutting blade.

In another embodiment, the present disclosure provides a system for manufacturing a material, the system including a working core configured to wind thereon a continuously manufactured material, a connection device configured to automatically connect the material wound on the working core to a standby core, and a tension control device configured to control the tension of the material connected to the standby core.

The connection device may include a first unit configured to hold and cut the material wound on the working core; and a second unit configured to hold the material cut by the first unit and connect the material to the standby core.

The system may include a connection film wound on the standby core and connected to the second unit. The system may further include a tape attached to the connection film to attach thereto the material cut by the first unit.

The tension control device may include a fixed guide configured to pass the material therethrough; and a movement guide configured to pass therethrough the material passing through the fixed guide and vertically movable.

The material may be configured to alternately pass through the fixed guide and the movement guide. The material may be a dry electrode of a battery.

The system may further include a roll press configured to roll a mixture of an electrode active material, a conductive additive, and a binder to continuously manufacture the material.

In still another embodiment, the present disclosure provides a method of manufacturing a material, the method including winding a continuously manufactured material on a first core, connecting the material to a second core at a first preset time point, and winding the material on the second core.

The method may further include controlling, by the tension control device, a tension of the material while the material is being wound on the second core.

The method may further include detecting, by a winding diameter sensor, the first preset time point while the material is being wound on the first core, wherein the winding diameter sensor is configured to detect an amount of the material wound on the first core.

The method may further include connecting, by the connection device, the material wound on the second core to the first core at a second preset time point; and winding the material on the first core. The second preset time point may be determined based on an amount of the material wound on the second core.

Other embodiments and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 illustrates a system for manufacturing a dry electrode according to an embodiment of the present disclosure;

FIG. 2 illustrates a process of manually connecting a dry electrode according to some embodiments of the present disclosure;

FIG. 3 is the area R1 of FIG. 1, illustrating an automatic connection device for a dry electrode according to some embodiments of the present disclosure;

FIG. 4 is a view of a tension control device according to an implementation of the present disclosure;

FIG. 5A illustrates a state in which a movement guide of a tension control device according to an implementation of the present disclosure is lowered;

FIG. 5B illustrates a state in which a movement guide of a tension control device according to an implementation of the present disclosure is lifted;

FIGS. 6A, 6B, 7A, 7B, and 7C illustrate the movement of a movement guide of a tension control device according to an implementation of the present disclosure;

FIGS. 8 to 10 illustrate a connection device according to an implementation of the present disclosure;

FIG. 11 illustrates a connection device according to a different implementation of the present disclosure;

FIGS. 12A and 12B illustrate the rotation of a fixed roller of a connection device;

FIGS. 13A and 13B illustrate the rotation of a swing roller of a connection device;

FIGS. 14A and 14B illustrate the rotation of a holder plate of a connection device;

FIG. 15 is a front view of a holder plate according to an implementation of the present disclosure, illustrating a state in which a connection film and a tape are connected to each other;

FIG. 16 illustrates the process of cutting a dry electrode on a holder plate according to an implementation of the present disclosure;

FIGS. 17A and 17B illustrate the operation process of a connection device, in which a dry electrode being manufactured is connected to a different winder when the dry electrode is fully wound on a lower roll core; and

FIGS. 18A and 18B illustrate the operation process of a connection device, in which a dry electrode being manufactured is connected to a different winder when the dry electrode is fully wound on an upper roll core.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and usage environment.

In the figures, reference numbers refer to the same or equivalent parts of the present disclosure throughout the several figures of the drawing.

### DETAILED DESCRIPTION

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Meanwhile, in the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of exemplary embodiments of the present disclosure.

It will be understood that, when a component is referred to as being “connected to” another component, the component may be directly connected to the other component, or intervening components may also be present. In contrast, when a component is referred to as being “directly connected to” another component, there is no intervening component present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

Hereinafter, the present disclosure will be described in detail with reference to the accompanying drawings.

A dry electrode may be manufactured in the form of an electrode sheet by pressing dry electrode powder using one or more roll presses. The manufactured electrode sheet may be wound into a roll.

When a dry electrode having a predetermined length is wound on one roll core, the roll core or a winder must be replaced with a new winder. Currently, the replacement is performed in such a manner that the production or winding equipment of a dry electrode is stopped and a roll core is replaced manually, which lowers productivity and increases labor consumption.

For other materials of a battery, such as a separator having an excellent tensile strength, there are cases where automation has been made. However, because the dry electrode has a low tensile strength, it is difficult to set up automatic replacement of the roll core in the conventional manufacturing system.

For this reason, the present disclosure provides a system capable of automatically replacing a roll core on which a dry electrode is wound.

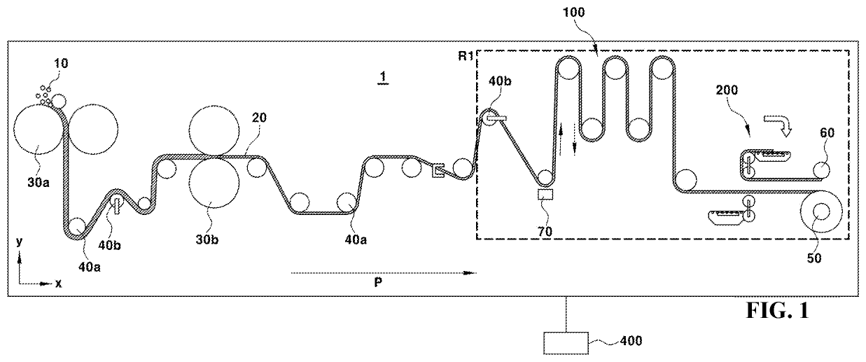

As illustrated in FIG. 1, a system 1 of manufacturing dry electrode may manufacture a dry electrode 20 from a dry electrode powder 10. The dry electrode powder 10 may be a mixture of an electrode active material, a conductive additive, and a binder. A cathode contains a cathode active material as an electrode active material. As a non-limiting example, the cathode active material may be nickel manganese cobalt (NMC) series, lithium ferrophosphate (LFP), lithium cobalt (LCO), or sulfur. An anode may contain an anode active material. As a non-limiting example, the anode active material may be graphite series and may contain silicon. As a non-limiting example, the conductive additive may contain a carbon-based material. In an example, the binder may contain polytetrafluoroethylene (PTFE), polyvinylidene fluoride (PVDF), or styrene butadiene rubber (SBR).

The manufactured dry electrode may move in a proceeding direction P and may be wound in the form of a roll using a winder. Particularly, the dry electrode powder 10 may be rolled using one or more roll presses 30a, 30b to be formed into the dry electrode 20 in the form of a continuous sheet. For example, the dry electrode powder 10 may be primarily pressed while moving in a vertical direction y by an upstream press 30a and may be secondarily pressed while moving in a horizontal direction x by a downstream press 30b. The dry electrode 20 may be pressed to have a required thickness while passing through the roll presses 30a, 30b.

A plurality of rollers 40a, 40b may be disposed in the system 1. For example, the rollers 40a, 40b may include one or more guide rollers 40a and one or more dancer rolls 40b. The guide rollers 40a may be configured to guide the proceeding of the dry electrode 20 being manufactured, and the dancer rolls 40b may be configured to adjust the tension of the proceeding dry electrode 20.

The dry electrode 20 being manufactured may be wound on a winder or a working core 50. The working core 50 may be configured to be rotatable and may wind thereon the dry electrode 20 being manufactured.

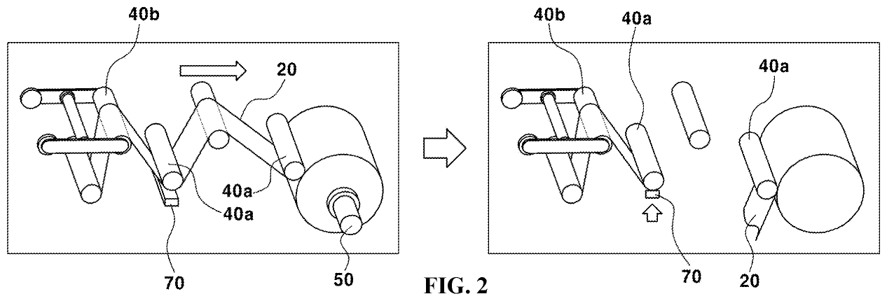

When the dry electrode 20 wound on the working core 50 has a predetermined volume or diameter, the working core 50 must be replaced with a new working core. According to an embodiment of the present disclosure, the working core 50 may be manually replaced with a new working core 50. Referring to FIG. 2, the system 1 may be stopped for the replacement. In order to cut the dry electrode 20 being continuously manufactured, the dry electrode 20 may be fixed using a stopper 70 disposed around at least one of the guide rollers 40a and may be cut at the working core 50 side. Then the roll on which the dry electrode 20 is fully wound may be removed from the working core 50. After the dry electrode 20 fixed to the stopper 70 is connected to the working core 50 again, the tension of the dry electrode 20 may be reset and the dry electrode manufacturing system 1 operates again. In such a method of manual replacement, operations, such as cutting the dry electrode 20 and reconnecting the cut dry electrode 20 to the working core 50, may be complicated and difficult. Further, because the connecting operation is manually performed by a worker, there is a concern that an initial quality degradation may occur. Moreover, when the dry electrode manufacturing system 1 is reconnected to the working core 50, the system 1 may be stopped and the replacement may be performed, which may cause loss of production time.

For this reason, according to a different embodiment of the present disclosure, when the dry electrode 20 is fully wound on the working core 50, the working core 50 may be automatically replaced with a standby core 60, which is a new working core 50. According to this embodiment, an automatic connection device capable of automatically replacing the working core 50, on which the dry electrode 20 is fully wound, without worker intervention is proposed.

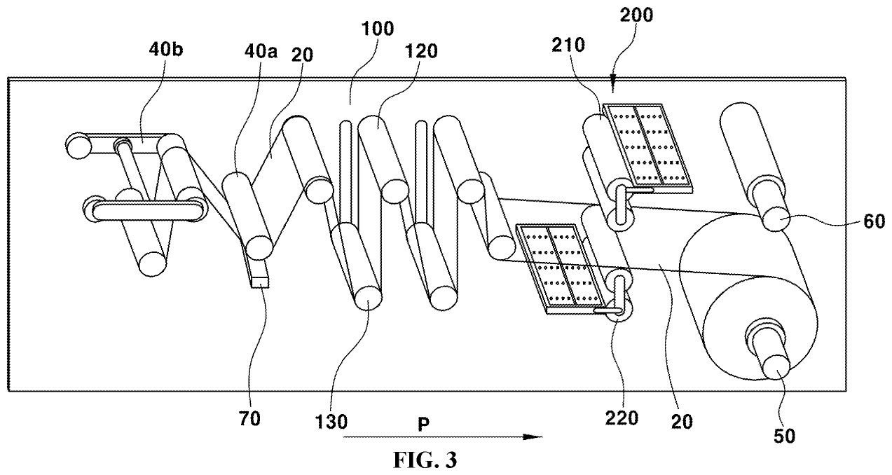

As illustrated in FIG. 3, the automatic connection device may include a tension control device 100. The tension control device may prevent breakage of a material or the dry electrode 20 when the system 1 restarts after automatically connecting the material or the dry electrode 20 to the standby core 60. Specifically, the tension control device 100 may solve the problem caused by low tensile strength of the dry electrode 20 and reduce the acceleration or deceleration time of the system 1 during high-speed operation of the system 1. Further, the automatic connection device may include a connection device 200 configured to automatically connect the dry electrode 20 to the standby core 60.

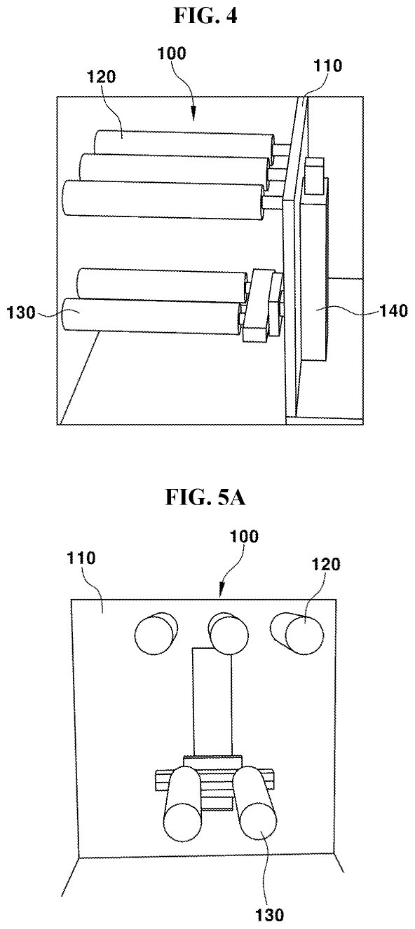

The tension control device 100 may control the tension of the dry electrode 20 when the working core 50 is replaced, separately from the dancer roll 40b. As illustrated in FIG. 4, according to an implementation of the present disclosure, the tension control device 100 may include a base 110, a fixed guide 120, and a movement guide 130.

The fixed guide 120 and the movement guide 130 may be mounted to the base 110. The fixed guide 120 may be fixed to the base 110, while the movement guide 130 may be movable on the base 110.

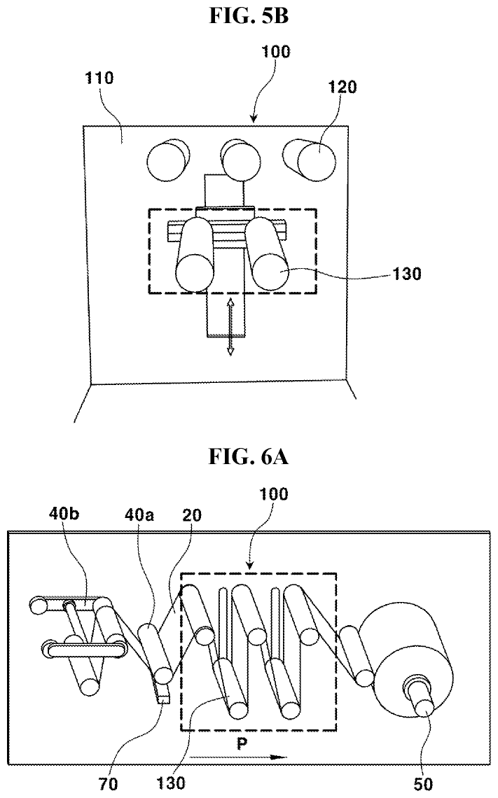

According to an embodiment of the present disclosure, the fixed guide 120 may be disposed above the movement guide 130 on the base 110 in the vertical direction y. As illustrated in FIGS. 5A and 5B, the movement guide 130 disposed below the fixed guide 120 may move toward the fixed guide 120 or away from the fixed guide 120. In one implementation, the movement guide 130 may receive a moving force from a linear actuator 140, such as a ball screw.

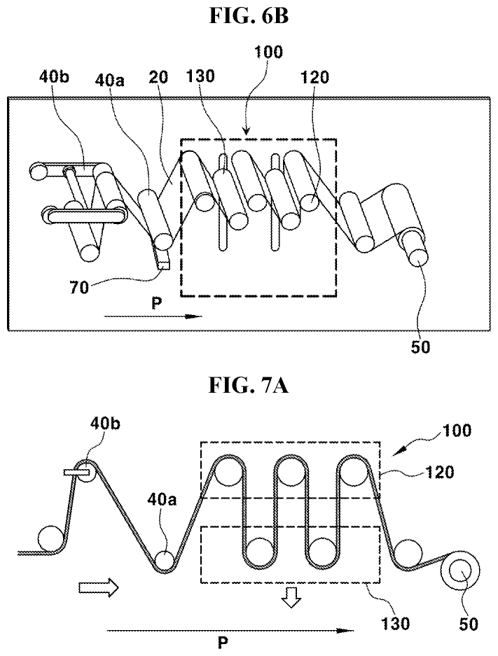

Referring to FIGS. 6A and 6B, the dry electrode 20 may pass through the fixed guide 120 and the movement guide 130, alternately. Accordingly, the tension of the dry electrode 20 may be adjusted depending on the distance between the movement guide 130 and the fixed guide 120. In the illustrated implementation, three fixed guides 120 and two movement guides 130 are shown, but the number thereof is not limited to the illustrated implementation and may be increased or decreased.

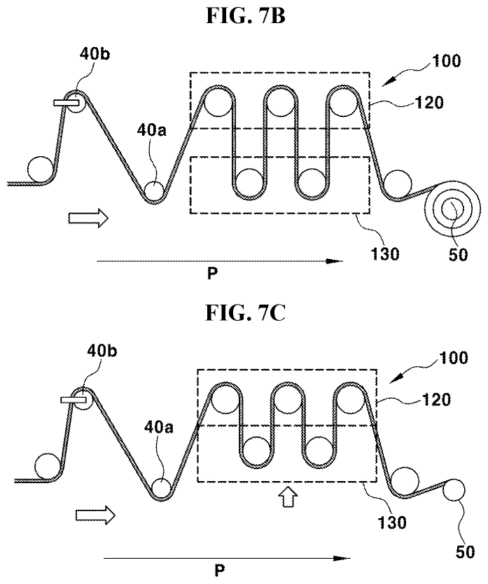

As illustrated in FIG. 7A, while the dry electrode 20 is being wound on the working core 50, the movement guide 130 may rotate and descend in a direction away from the fixed guide 120. Then, as illustrated in FIG. 7B, when the dry electrode 20 is fully wound on the working core 50, the movement guide 130 may stop at a lowest position. When the working core 50 is replaced with the standby core 60, which is a new working core 50, and starts to run again, the system 1 may operate while maintaining the tension of the dry electrode 20 as the movement guide 130 ascends matching the moving speed of the replaced winder (i.e., the new working core 50) as illustrated in FIG. 7C.

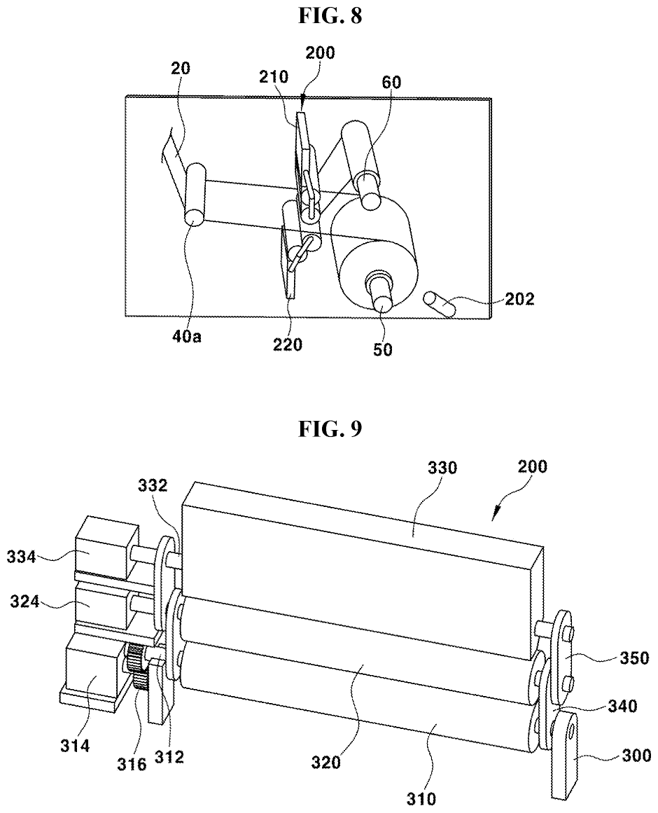

Referring to FIG. 8, the connection device 200 may allow the dry electrode 20 to be automatically connected to the standby core 60 when the dry electrode 20 is fully wound on the working core 50.

Full winding of the dry electrode 20 may be determined by a winding diameter sensor 202. In one implementation, the winding diameter sensor 202 may be disposed around the working core 50. The winding diameter sensor 202 may detect whether the dry electrode 20 is fully wound on the working core 50 or whether the dry electrode 20 is wound on the working core 50 up to a predetermined diameter or volume.

When the dry electrode 20 is fully wound on the working core 50, the connection device 200 may connect the dry electrode 20 being manufactured to the standby core 60. To this end, in one implementation, the connection device 200 includes an upper unit 210 and a lower unit 220. Although the upper unit 210 and the lower unit 220 are identical to each other as will be described below, the upper unit 210 and the lower unit 220 may operate differently during replacement. According to an implementation of the present disclosure, the connection device 200, or the upper unit 210 and the lower unit 220 each may include a frame 300, a fixed roller 310, a swing roller 320, and a holder plate 330.

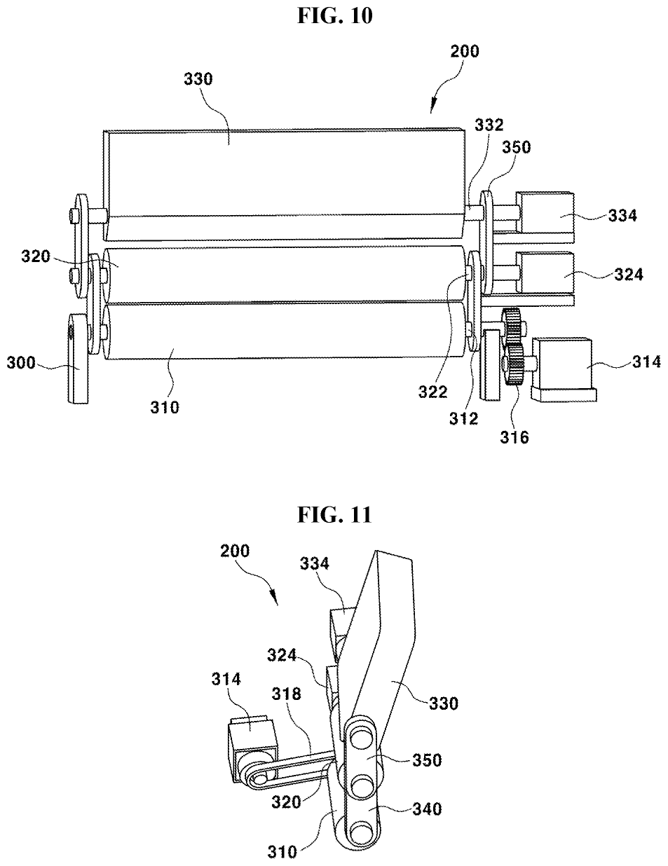

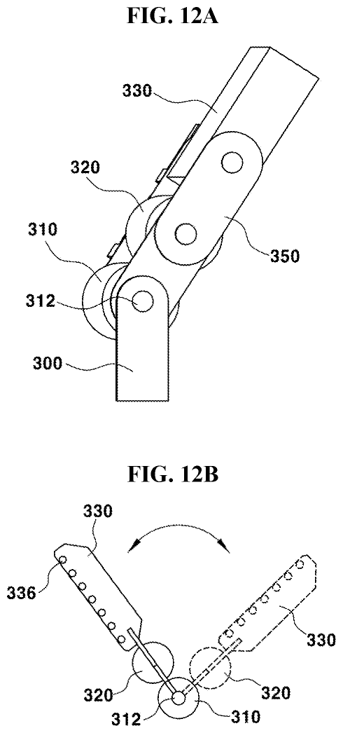

Referring to FIGS. 9 to 10, the connection device 200 may be disposed around the dry electrode 20, being manufactured, by the frame 300. The connection device 200 may be fixed at an appropriate position by the frame 300 in consideration of the size of the dry electrode 20 being manufactured, the design of the system 1, and the like.

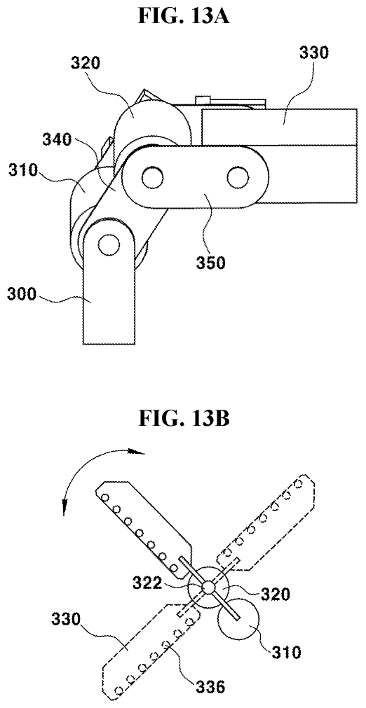

The fixed roller 310 may be connected to the frame 300. The fixed roller 310 may be mounted to the frame 300 by being rotatable about a shaft 312. The fixed roller 310 may receive a rotational force from a motor 314 of the fixed roller 310. In an implementation, the shaft 312 of the fixed roller 310 may be disposed parallel to a rotating axis of the motor 314 of the fixed roller 310 via a gear 316 and engaged therewith to be operatively associated with each other. In a different implementation, as illustrated in FIG. 11, a timing belt 318, instead of the gear 316, may be configured to rotate together with the shaft 312 of the fixed roller 310 upon driving of the motor 314 of the fixed roller 310.

The connection device 200 may include the swing roller 320. The swing roller 320 may be configured to be rotatable. In one implementation, a shaft 322 of the swing roller 320 may be rotatable by a motor 324 of the swing roller 320.

A connection structure is provided between the fixed roller 310 and the swing roller 320. In one implementation, the connection structure may include a proximal link 340. Specifically, the swing roller 320 may be connected to the fixed roller 310 via the proximal link 340. One side of the proximal link 340 may be coupled to the shaft 312 of the fixed roller 310, and the other side of the proximal link 340 may be coupled to the shaft 322 of the swing roller 320. The swing roller 320 connected to the fixed roller 310 via the proximal link 340 may rotate about the shaft 312 of the fixed roller 310 by the rotation of the fixed roller 310.

The connection device 200 may further include the holder plate 330. The holder plate 330 may be rotatable about a shaft 332 of the holder plate 330. In one implementation, the shaft 332 of the holder plate 330 may be rotated by a motor 334 of the holder plate 330.

Between the swing roller 320 and the holder plate 330, a connection structure may be provided. The connection structure may include a distal link 350. The holder plate 330 may be connected to the swing roller 320 via the distal link 350. The shaft 332 of the holder plate 330 may be coupled to one side of the distal link 350, and the shaft 322 of the swing roller 320 may be coupled to the other side of the distal link 350.

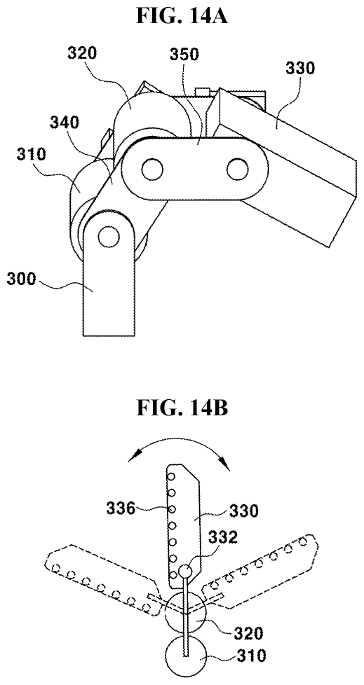

As illustrated in FIGS. 12A and 12B, when the motor 314 of the fixed roller 310 operates, the swing roller 320 and the holder plate 330 connected to the shaft 312 of the fixed roller 310 via the proximal link 340 and the distal link 350 may rotate about the shaft 312 of the fixed roller 310.

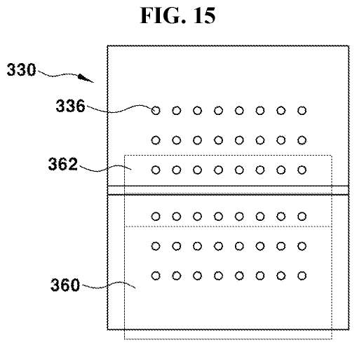

As illustrated in FIGS. 13A and 13B, the swing roller 320 may rotate about the shaft 322 of the swing roller 320 by the operation of the motor 324 of the swing roller 320, and the holder plate 330 connected to the shaft 322 of the swing roller 320 via the distal link 350 may also rotate together therewith.

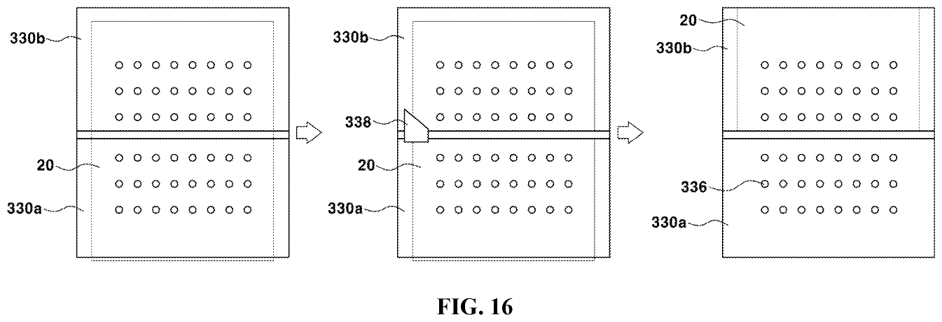

Referring to FIGS. 14A and 14B, by the operation of the motor 334 of the holder plate 330, the holder plate 330 may rotate about the shaft 332 of the holder plate 330.

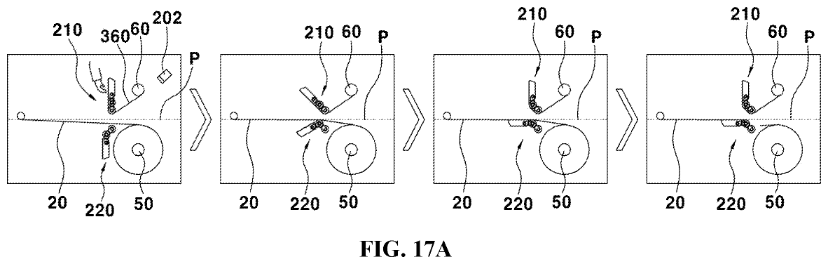

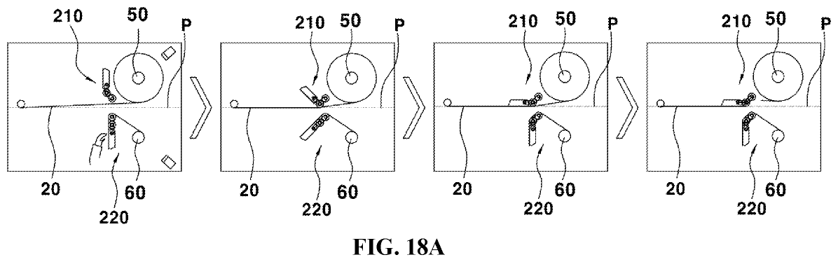

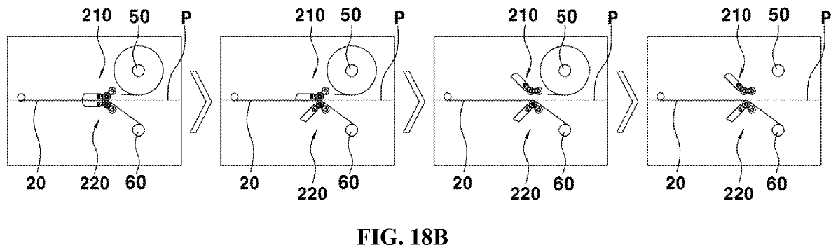

As illustrated in FIG. 15, the holder plate 330 may be connected to a connection film 360 configured to connect the standby core 60 and the dry electrode 20 to each other. Further, a tape 362 for connection of the dry electrode 20 may be attached to the connection film 360. The replacement operation for the connection film 360 and the tape 362 will be described in more detail below with reference to FIGS. 17A, 17B, 18A, and 18B.

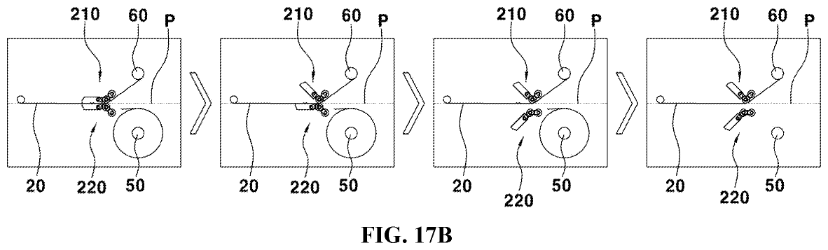

Referring to FIG. 16, in one implementation, a plurality of holes 336 may be arranged in the holder plate 330 for vacuum adsorption. Some of the plurality of holes 336 may be formed in a first area of the holder plate 330, and the rest of the plurality of holes 336 may be formed in a second area 330b of the holder plate 330. Vacuum provided on the first area 330a and vacuum provided on the second area 330b may be controlled separately from each other. In other words, adsorption may be performed in the first area 330a but not in the second area 330b, and vice versa. Further, adsorption may be performed simultaneously in the first area 330a and the second area 330b.

According to an implementation of the present disclosure, the holder plate 330 may include a protrusible cutting blade 338. The cutting blade 338 may cut the dry electrode 20 wound on the working core 50 to discontinue vacuum at the working core 50 side, thus separating the dry electrode 20 wound on the working core 50. For example, after cutting the dry electrode 20, vacuum on the first area 330a of the holder plate 330 may be discontinued. Then the dry electrode 20 wound on the working core 50 may be separated from the holder plate 330 and from the dry electrode 20 being continuously manufactured. In this state, the vacuum on the second area 330b of the holder plate 330 may be maintained so that the dry electrode 20 being continuously manufactured may be held by the holder plate 330.

The standby core 60 may include the connection film 360 wound thereon. The connection film 360 may be used for smoothly connecting the dry electrode 20 to a new roll core and for prevention of breakage of the dry electrode 20. As a non-limiting example, the connection film 360 may be a polyethylene terephthalate (PET) film.

The tape 362 may be attached to an end of the connection film 360. The tape 362 may be attached to the dry electrode 20 being manufactured, which is to be placed on the second area 330b, thereby facilitating connecting seams.

The controller 400 may be configured to control the system 1. For example, the controller 400 may receive a detection signal from the winding diameter sensor 202, recognize a full winding of the working core 50 in operation based on the received detection signal, and determine when to replace the working core 50. Further, the controller 400 may change the position of the movement guide 130 of the tension control device 100 to control the tension of the dry electrode 20 after replacing the working core 50. Furthermore, the controller 400 may control the operation of the connection device 200.

Hereinafter, the operation of the connection device 200 is described in detail with reference to FIGS. 17A, 17B, 18A, and 18B.

So as to replace the fully wound winder or working core 50, the working core 50 and the standby core 60 may switch their roles. In other words, while the dry electrode 20 is continuously manufactured, the working core 50 may become the standby core 60 and the standby core 60 may become the working core 50. When the dry electrode 20 is fully wound on the working core 50 at the lower side in the illustrated implementation shown in FIG. 1 and others, the dry electrode 20 is automatically connected to the standby core 60 at the upper side. Here, the standby core 60 at the upper side becomes the working core 50, and the working core 50 at the lower side becomes the standby core 60.

In FIGS. 17A and 17B, the winder at the lower side may work as the working core 50. While the working core 50 winds thereon the dry electrode 20, the connection film 360 is wound on the standby core 60 at the upper side. For example, the connection film 360 may be pre-connected to the standby core 60 by a worker, while the working core 50 winds thereon the dry electrode 20. The connection film 360 connected to the standby core 60 is connected to the upper unit 210 of the connection device 200. Specifically, in order to facilitate connection between the connection film 360 and the dry electrode 20 to be held by the holder plate 330 of the upper unit 210, the tape 362 may be attached to the end of the connection film 360.

As in FIG. 17A, when the winding diameter sensor 202 detects full winding of the working core 50, the connection device 200 may start to operate by the controller 400.

In the lower unit 220, rotation of the shaft 312 of the fixed roller 310 of the lower unit 220 may cause the swing roller 320 and the holder plate 330 to rotate toward the dry electrode 20. The swing roller 320 of the lower unit 220 may be rotated about the shaft 322 of the swing roller 320 and may be brought into contact with the dry electrode 20. Then the holder plate 330 of the lower unit 220 may be rotated about the shaft 332 and may be positioned to be parallel with the dry electrode 20 to hold or adsorb the dry electrode 20. While the dry electrode 20 is adsorbed on the holder plate 330, the cutting blade 338 may be protruded from the lower unit 220 to cut the dry electrode 20. In the holder plate 330 of the lower unit 220, vacuum adsorption in the second area 330b may continue and vacuum adsorption in first area 330a may be ceased to separate the fully wound winder at the lower side from the system 1.

In the upper unit 210, in the state in which the connection film 360 is connected, the fixed roller 310, the swing roller 320, and the holder plate 330 may rotate about the shaft 312 of the fixed roller 310 towards the dry electrode 20. Then the holder plate 330 of the upper unit 210 may be disposed in a tilted position rotated substantially vertically with respect to the dry electrode 20. The upper unit 210 maintains the tilted position until the dry electrode 20 is cut by the lower unit 220.

Referring to FIG. 17B, when cutting by the lower unit 220 is completed, the upper unit 210 may rotate towards the dry electrode 20. Specifically, the upper unit 210 may rotate about the shaft 312 of the fixed roller 310, and the holder plate 330 of the upper unit 210 may be brought into contact with the dry electrode 20. Because the tape 362 is attached to the holder plate 330 of the upper unit 210 brought into contact with the dry electrode 20, the tape 362 may be connected to the dry electrode 20. Adsorption by the lower unit 220 may be stopped and the standby core 60 is rotated, so that the dry electrode 20 connected to the standby core 60 is wound on the standby core 60. The holder plate 330 of the upper unit 210 may be rotated about the shaft 332 of the holder plate 330 in a direction away from the dry electrode 20. The lower unit 220 may be rotated about the shaft 312 of the fixed roller 310 of the lower unit 220 in a direction away from the dry electrode 20. Here, the tension control device 100 may be operated to control the tension of the dry electrode 20 so that the dry electrode 20 may be wound on a new working core 50 at the upper side without breakage.

As such, the winder at the upper side, which was the standby core 60 in the standby state, may be switched to serve as the working core 50 and wind thereon the dry electrode 20. Then the roll core at the lower side may be switched to the standby state and becomes the standby core 60.

FIGS. 18A and 18B illustrate a process in which the dry electrode 20 is alternatingly connected to the standby core 60 at the lower side after completing winding of the core 60 at the upper side of FIGS. 17A and 17B. The operation in FIGS. 18A and 18B may be performed in the same manner as the operation in FIGS. 17A and 17B and only the direction is opposite, so redundant descriptions will be omitted.

Although a dry electrode is described as an example in this specification, the connection device according to the present disclosure may be used not only for manufacturing the dry electrode but also for manufacturing other materials having a low tensile strength. The present disclosure may enable automatic connection of a material having a low tensile strength, such as a dry electrode.

According to the present disclosure, the workload of a worker for reconnecting a material may be reduced, and the quality of the connected portion of the material may be improved.

Further, according to the present disclosure, a tension control device may adjust the tension of a material when the material is connected to a new winder, thereby preventing breakage of the material.

According to the present disclosure, a material may be automatically connected to a new winder, thereby reducing the time for manual connection and increasing yield.

As is apparent from the above description, the present disclosure provides the following effects.

According to the present disclosure, there may be a device configured to automatically connect a continuously manufactured material to a new winder.

Specifically, according to the present disclosure, there may be a device for automatically connecting a material, the device capable of preventing breakage of the material having a low tensile strength.

Further, according to the present disclosure, a continuously manufactured material may be automatically connected to a new winder, thereby increasing productivity.

Effects of the present disclosure are not limited to what has been described above, and other effects not mentioned herein will be clearly recognized by those skilled in the art based on the above description.

It will be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. A device for automatically connecting a material, the device comprising:
a fixed roller rotatably fixed, the fixed roller being rotatable about a shaft of the fixed roller;
a swing roller rotatable by a rotation of the fixed roller, the swing roller being rotatable about a shaft of the swing roller; and
a holder plate rotatable together with the fixed roller and configured to hold the material.

2. The device according to claim 1, wherein the holder plate is connected to the fixed roller via the swing roller.

3. The device according to claim 1, further comprising a proximal link configured to connect the swing roller and the fixed roller to each other.

4. The device according to claim 1, further comprising a distal link configured to connect the swing roller and the holder plate to each other.

5. The device according to claim 1, wherein the holder plate is configured to hold the material by vacuum adsorption.

6. The device according to claim 5, wherein the holder plate comprises a plurality of holes for the vacuum adsorption.

7. The device according to claim 1, wherein the holder plate comprises a protrusible cutting blade.

8. A system for manufacturing a material, the system comprising:
a working core configured to wind thereon a continuously manufactured material;
a connection device configured to automatically connect the material wound on the working core to a standby core; and
a tension control device configured to control a tension of the material connected to the standby core.

9. The system according to claim 8, wherein the connection device comprises:
a first unit configured to hold and cut the material wound on the working core; and
a second unit configured to hold the material cut by the first unit and connect the material to the standby core.

10. The system according to claim 9, further comprising a connection film wound on the standby core and connected to the second unit.

11. The system according to claim 10, further comprising a tape attached to the connection film to attach thereto the material cut by the first unit.

12. The system according to claim 8, wherein the tension control device comprises:
a fixed guide configured to pass the material therethrough; and
a movement guide configured to pass therethrough the material passing through the fixed guide and vertically movable.

13. The system according to claim 12, wherein the material is configured to alternately pass through the fixed guide and the movement guide.

14. The system according to claim 8, wherein the material is a dry electrode of a battery.

15. The system according to claim 8, further comprising a roll press configured to roll a mixture of an electrode active material, a conductive additive, and a binder to continuously manufacture the material.

16. A method of manufacturing a material, the method comprising:
winding a continuously manufactured material on a first core;
connecting the material to a second core at a first preset time point; and
winding the material on the second core.

17. The method according to claim 16, further comprising controlling, by the tension control device, a tension of the material while the material is being wound on the second core.

18. The method according to claim 16, further comprising detecting, by a winding diameter sensor, the first preset time point while the material is being wound on the first core,
wherein the winding diameter sensor is configured to detect an amount of the material wound on the first core.

19. The method according to claim 16, further comprising:
connecting, by the connection device, the material wound on the second core to the first core at a second preset time point; and
winding the material on the first core.

20. The method according to claim 19, wherein the second preset time point is determined based on an amount of the material wound on the second core.
